(19) United States
(12) Patent Application Publication
(10) Pub. No.: US 2013/0176550 A1
(43) Pub. Date: Jul. 11, 2013

(54) IMAGE SENSOR, IMAGE SENSING METHOD, AND IMAGE PHOTOGRAPHING APPARATUS INCLUDING THE IMAGE SENSOR

(71) Applicants: Ilia OVSIANNIKOV, Studio City, CA (US); Pravin Rao, San Jose, CA (US)

(72) Inventors: Ilia OVSIANNIKOV, Studio City, CA (US); Pravin Rao, San Jose, CA (US)

(21) Appl. No.: 13/347,036

(22) Filed: Jan. 10, 2012

(51) Int. Cl. G01C 3/08

(52) U.S. Cl. 356/5.01

(57) ABSTRACT

An image sensor includes a pixel array sensing a plurality of modulation signals having different phases from the reflected light and outputting pixel output signals corresponding to the plurality of modulation signals, a depth information calculation unit for estimating a delay between the output light and the reflected light from images formed from the pixel output signals and calculating depth information regarding the object, and an integration time register. When integration times corresponding to the images used to calculate the depth information in the depth information calculation unit are different from each other, the integration time register obtains a gain corresponding to a difference between the integration times and the depth information calculation unit applies the gain to images having different integration times.

### 1. FIELD

Embodiments relate to an image sensor, an image sensing method, and an image capturing apparatus including the image sensor, and more particularly, to an image sensor capable enabling range calculation in the presenceof a change in integration time, an image sensing method, and an image capturing apparatus including the image sensor.

### 2. DESCRIPTION OF THE RELATED ART

Technologies regarding image capturing apparatuses and methods are being developed fast. In order to more accurately sense image information, image sensors capable of obtaining depth information together with color information regarding an object are being developed.

### SUMMARY

According to embodiments, an image sensor for receiving reflected light from an object having output light incident thereon may include a pixel array having a plurality of pixels for sensing a plurality of modulation signals having different phases from the reflected light and outputting pixel output signals corresponding to the plurality of modulation signals, a depth information calculation unit for estimating a delay between the output light and the reflected light from images formed by the pixel output signals and calculating depth information regarding the object, and an integration time register that, when integration times corresponding to the images used to calculate the depth information in the depth information calculation unit are different, obtains a gain corresponding to a difference between the integration times, wherein the depth information calculation unit applies the gain to images having different integration times when the integration times corresponding to the images used to calculate the depth information in the depth information calculation unit are different from each other.

When the integration time corresponding to each of the images is a first integration time or a second integration time, the gain may be a ratio of the first integration time and the second integration time.

When the integration time register sets the gain greater than 1, the depth information calculation unit may apply the gain for at least one image having a shorter one of the first integration time and the second integration time.

When the integration time register sets the gain smaller than 1, the depth information calculation unit may apply the gain for at least one image having a longer one of the first integration time and the second integration time.

The depth information calculation unit may subtract a value of a black level from the value of one image among the images having different integration times, apply the gain to the resulting value, and add the value of the black level to the one image having the gain applied thereto.

Each of the plurality of modulation signals may be phase modulated to one of 0 degree, 90 degrees, 180 degrees, and 270 degrees with respect to the output light.

The pixel array may include color pixels for generating the pixel output signals by receiving a wavelength of a band for detecting color information of the object from the reflected light and depth pixels for generating the pixel output signals by receiving a wavelength of a band for detecting depth information of the object from the reflected light. The image sensor may include a color information calculation unit for receiving the pixel output signals output from the color pixels and calculating the color information.

The image sensor may be a time of flight (TOF) sensor.

According to embodiments, an image sensing method includes receiving reflected light from an object having output light incident thereon, sensing a plurality of modulation signals having different phases from the reflected light and outputting pixel output signals corresponding to the plurality of modulation signals, estimating a delay between the output light and the reflected light from images having the same number as types of the plurality of modulation signals among images formed by the pixel output signals and are continuously sensed, and calculating depth information regarding the object, wherein calculating the depth information includes, when integration times corresponding to the images having the same number as types of the plurality of modulation signals used to calculate the depth information are different from each other, applying a gain corresponding to a difference between the integration times to the images having different integration times.

When the integration time corresponding to each of the images used to calculate the depth information is first integration time or the second integration time, the gain may be a ratio of the first integration time and the second integration time.

When the gain is greater than 1, the gain may be applied to at least one image having a shorter one of the first integration time and the second integration time.

When the gain is smaller than 1, the gain may be applied to at least one image having a longer one of the first integration time and the second integration time.

Calculating of the depth information may include subtracting a value of a black level from the value of an image among the images having different integration times, applying the gain to the one image after subtracting the value of the black level therefrom, and adding the value of the black level to the one image to which the gain has been applied.

Each of the plurality of modulation signals may be phase modulated to one of 0 degree, 90 degrees, 180 degrees, and 270 degrees with respect to the output light.

The method may include receiving the pixel output signals output from the color pixels and calculating the color information regarding the object.

According to embodiments, an image sensor for receiving reflected light from an object having output light incident thereon includes a pixel array having a plurality of pixels for sensing a plurality of modulation signals having different phases from the reflected light and outputting pixel output signals corresponding to the plurality of modulation signals, a depth information calculation unit for estimating a delay between the output light and the reflected light from images formed by the pixel output signals and calculating depth information regarding the object in accordance with the delay, and an integration time register that, when integration times corresponding to the images used to calculate the depth information in the depth information calculation unit are different, selects a reference integration time from the integration times and obtains a corresponding gain for a corresponding image having a corresponding integration time different from the reference integration time, the corresponding gain being proportional to a difference between the corresponding integration time and the reference integration time, wherein the depth information calculation unit applies corresponding gains to corresponding images having integration times different from the reference integration time.

The reference integration time may be a longest integration time of the integration times.

The corresponding gain may be the ratio of the reference integration time to the corresponding integration time.

The reference integration time may be a shortest integration time of the integration times.

The corresponding gain may be the ratio of the corresponding integration time to the reference integration time.

### BRIEF DESCRIPTION OF THE DRAWINGS

Features will become apparent to those of ordinary skill in the art by describing in detail exemplary embodiments with reference to the attached drawings in which:

FIG. 1 illustrates a block diagram of an image sensor according to an embodiment of the inventive concept;

FIGS. 2A and 2B illustrate diagrams for describing operation of the image sensor illustrated in FIG. 1;

FIGS. 3A and 3B illustrate diagrams showing alignments of pixels illustrated in FIG. 1;

FIG. 4 illustrates graphs of modulation signals used when the image sensor illustrated in FIG. 1 senses an image;

FIG. 5 illustrates a diagram showing an example of a sequence of images captured from continuously received reflected light;

FIG. 6 illustrates a diagram showing a sequence of images when an integration time is reduced;

FIG. 7 illustrates a diagram showing a sequence of images when an integration time is increased;

FIG. 8 illustrates a flowchart of an image sensing method according to an embodiment of the inventive concept;

FIG. 9 illustrates a block diagram of an image capturing apparatus according to an embodiment of the inventive concept;

FIG. 10 illustrates a block diagram of an image capturing and visualization system according to an embodiment of the inventive concept; and

FIG. 11 illustrates a block diagram of a computing system according to an embodiment of the inventive concept.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

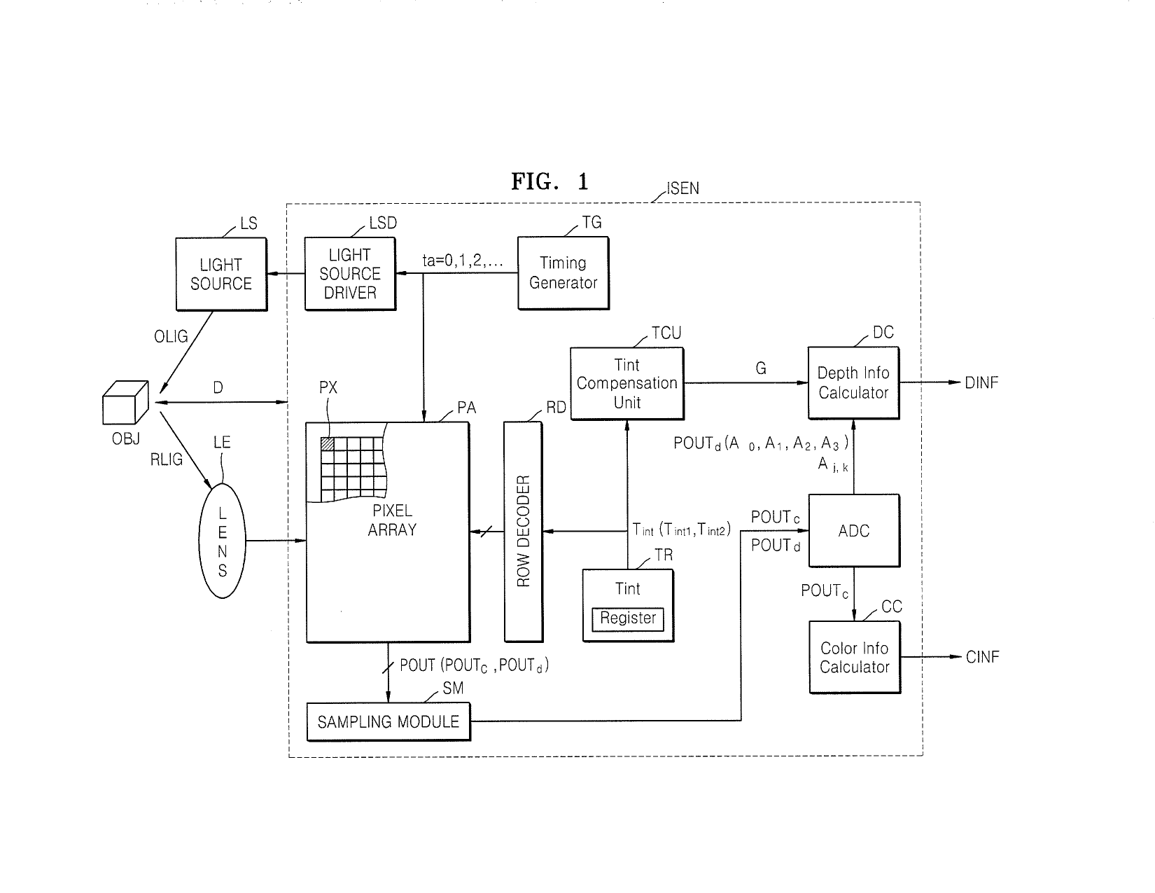

FIG. 1 illustrates a block diagram of an image sensor ISEN according to an embodiment of the inventive concept.

Referring to FIG. 1, the image sensor ISEN includes a pixel array PA, a timing generator TG, a row driver RD, a sampling module SM, an analog-to-digital converter ADC, a color information calculator CC, a depth information calculator DC, and an integration time resgister TR. The image sensor ISEN may be a time-of-flight (TOF) image sensor that senses image information (color information CINF and depth information DINF) of an object OBJ.

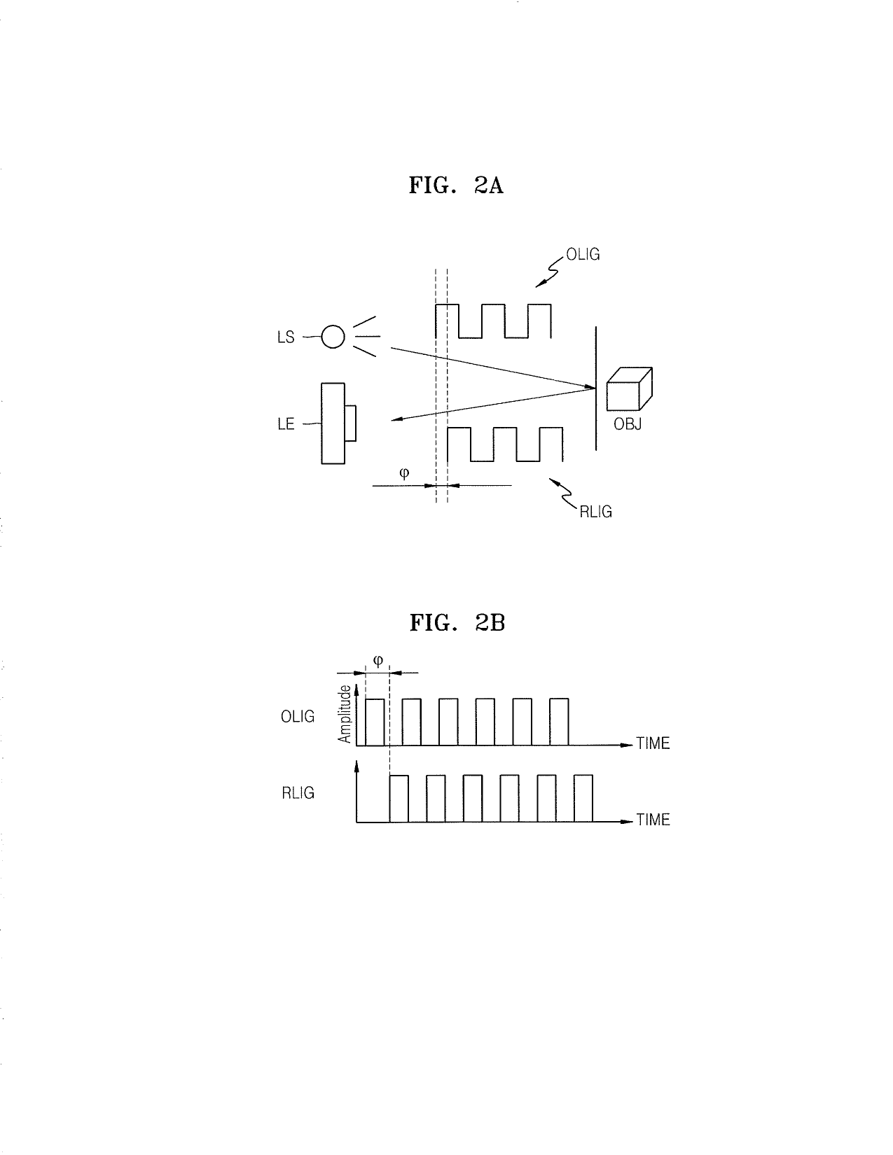

As shown in detail in FIG. 2A, the image sensor ISEN senses depth information DINF of the object OBJ from reflected light RLIG received through a lens LE after output light OLIG emitted from a light source LS has been incident thereon. In this case, as shown in FIG. 2B, the output light OLIG and the reflected light RLIG may have periodical waveforms shifted by a phase delay of φ relative to one another. The image sensor ISEN may sense color information CINF from the visible light of the object OBJ.

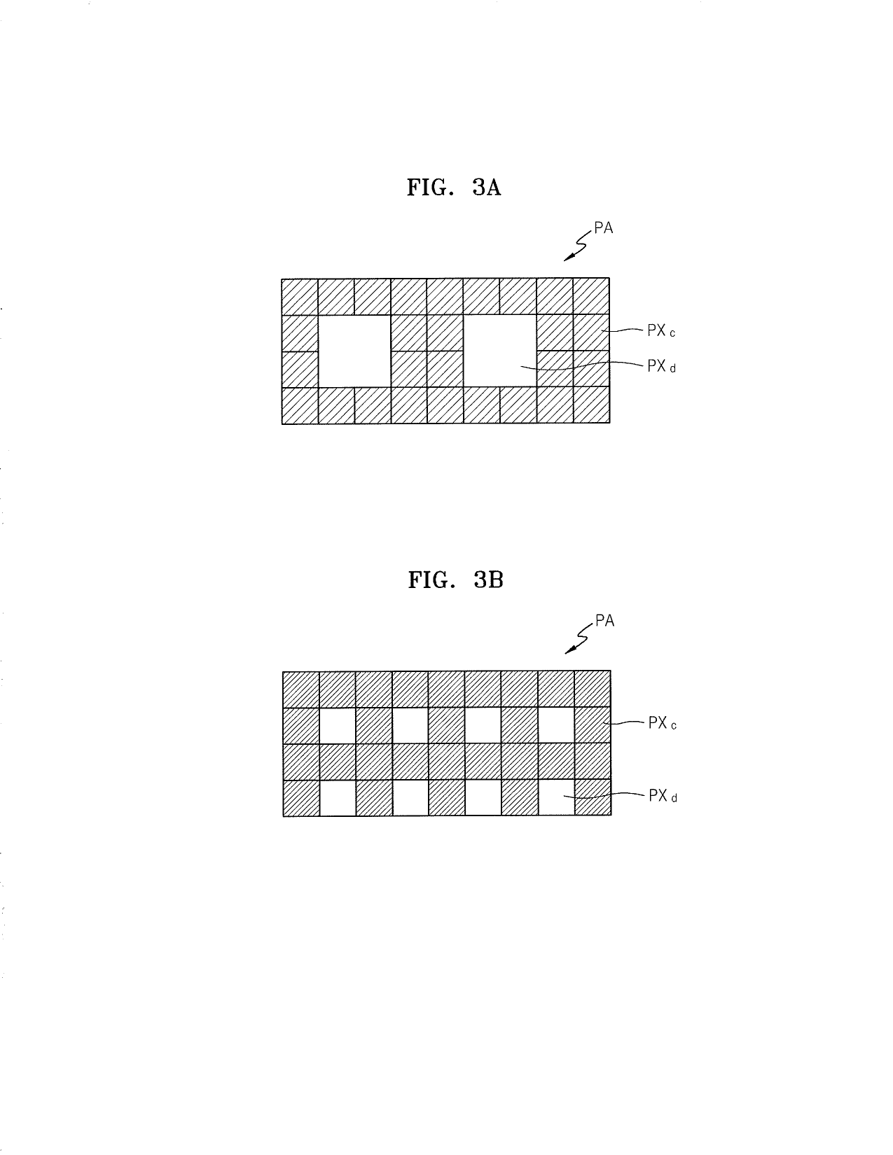

Referring again to FIG. 1, the pixel array PA includes a plurality of pixels PX arranged at intersections of rows and columns. The pixel array PA may include the pixels PX arranged in various ways. For example, as illustrated in FIG. 3A, while depth pixels PXd are larger in size than color pixels PXc, the depth pixels PXd may be smaller in number than the color pixels PXc. Alternatively as illustrated in FIG. 3B, the depth pixels PXd and the color pixels PXc may be the same size, and the depth pixels PXd may be smaller in number than the color pixels PXc. In the particular configuration illustrated in FIG. 3B, the depth pixels PXd and the color pixels PXc may be alternately arranged in alternate rows, i.e., a row may contain all color pixels PXc followed by a row containing alternating color pixels PXc and depth pixels PXd . The depth pixels PXd may sense infrared light of the reflected light RLIG. The color pixel array PA may also include depth pixels only if the sensor is capable of capturing only range images without color information.

Although the color pixels PXc and the depth pixels PXd are separately arranged in FIGS. 3A and 3B, the present embodiment is not limited thereto. The color pixels PXc and the depth pixels PXd may be integrally arranged.

The depth pixels PXd may each include a photoelectric conversion element (not shown) for converting the reflected light RLIG into an electric change. The photoelectric conversion element may be a photodiode, a phototransistor, a photo-gate, or a pinned photodiode. Also, the depth pixels PXd may each include some transistors which are connected to the photoelectric conversion element, and control the photoelectric conversion element or output an electric change of the photoelectric conversion element as pixel signals. Especially, read-out transistor included in each of the depth pixels PXd may output an output voltage corresponding to reflected light received by the photoelectric conversion element of each of the depth pixels PXd as pixel signals. Also, the color pixels PXc may each include a photoelectric conversion element (not shown) for converting the visible light into an electric change. A structure and a function of each pixel will not be explained in detail.

If the pixel array PA of the present embodiment separately includes the color pixels PXc and the depth pixels PXd as shown in FIGS. 3A and 3B, pixel signals may be divided into color pixel signals POUTc output from the color pixels PXc and used to obtain color information CINF, and depth pixel signals POUTd output from the depth pixels PXd and used to obtain depth information DINF.

Referring again to FIG. 1, the light source LS is controlled by a light source driver LSD that may be located inside or outside the image sensor ISEN. The light source LS may emit the output light OLIG modulated at a time (clock) ‘ta’ applied by the timing generator TG. The timing generator TG also controls other components of the image sensor ISEN, e.g., the row decoder RD, the sampling module SM, etc.

The timing generator TG controls the depth pixels PXd to be activated so that the depth pixels PXd of the image sensor ISEN may demodulate from the reflected light RLIG synchronously with the clock ‘ta’. The photoelectric conversion element of each the depth pixels PXd outputs electric charges accumulated with respect to the reflected light RLIG for a depth integration time Tint_Dep as depth pixel signals POUTd. The photoelectric conversion element of each the color pixels PXc outputs electric charges accumulated with respect to the visible light for a color integration time Tint_Col as color pixel signals POUTc. A detailed explanation of the color integration time Tint_Col and the depth integration time Tint_Dep will be made with reference to the integration time registerregister TR.

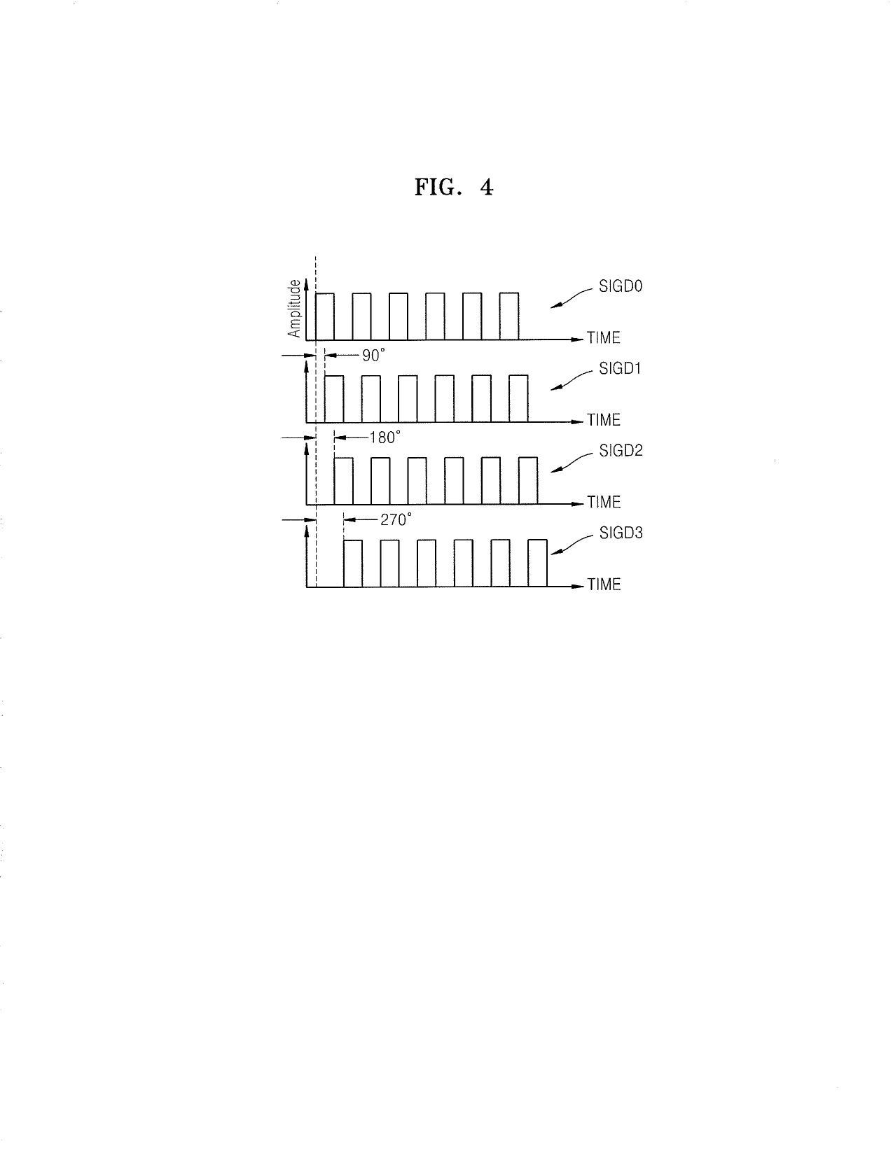

The depth pixel signals POUTd of the image sensor ISEN are output to correspond to a plurality of demodulated optical wave pulses from the reflected light RLIG which includes modulated optical wave pulses. For example, FIG. 4 is a diagram illustrating modulated signals used to illuminate an image in the image sensor ISEN of FIG. 1. Referring to FIG. 4, each of the depth pixels PXd may receive a demodulation signal, for example SIGD0, and illumination by four modulated signals SIGD0 through SIGD3 whose phases are shifted respectively by 0, 90, 180, and 270 degrees from the output light OLIG, and output corresponding depth pixel signals POUTd. The resulting depth pixel outputs for each captured frame are designated correspondingly as A0, A1, A2 and A3. Also, the color pixels PXc receive illumination by the visible light and output corresponding color pixel signals POUTc. Alternatively, referring to FIG. 4, each of the depth pixels PXd may receive illumination by one modulated signal only, for example SIGD0, while the demodulation signal phase changes from SIGD0 to SIGD3 to SIGD2 to SIGD1. The resulting depth pixel outputs for each captured frame are also designated correspondingly as A0, A1, A2 and A3.

Referring back to FIG. 1, the sampling module SM samples such depth pixel signals POUTd from the depth pixels PXd and sends the depth pixel signals POUTd to the analog-to-digital converter ADC. Also, the sampling module SM samples such color pixel signals POUTc from the color pixels PXc and sends the color pixel signals POUTc to the analog-to-digital converter ADC. The analog-to-digital converter ADC converts the pixel signals POUTc and POUTd each having an analog voltage value into digital data. Even though the sampling module SM or the analog-to-digital converter ADC may operate at the different time for the color pixel signals POUTc and the depth pixel signals POUTd, the image sensor may output the color information CINF is in synchronization with the depth information DINF. For example, the sampling module SM may read out the pixel signals POUTc and POUTd simultaneously.

The color information calculator CC calculates the color information CINF from the color pixel signals POUTc converted to digital data by the analog-to-digital converter ADC.

The depth information calculator DC calculates the depth information DINF from the depth pixel signals POUTd=A0 through A3 converted to digital data by the analog-to-digital converter ADC. In detail, the depth information calculator DC estimates a phase delay φ between the output light OLIG and the reflected light RLIG as shown in Equation 1, and determines a distance D between the image sensor ISEN and the object OBJ as shown in Equation 2.

$$\begin{matrix}ϕ = arctan ( \frac{{A}_{3} - {A}_{1}}{{A}_{2} - {A}_{0}} ) & [ Equation 1 ] \\ D = \frac{c}{4 \cdot {F}_{m} \cdot π} * ϕ & [ Equation 2 ]\end{matrix}$$

In Equation 2, the distance D between the image sensor ISEN and the object OBJ is a value measured in the unit of meter, Fm is a modulation wave period measured in the unit of second, and ‘c’ is a speed of light measured in the unit of m/s. It is found that the distance D between the image sensor ISEN and the object OBJ may be sensed as the depth information DINF from the depth pixel signals POUTd output from the depth pixels PXd of FIG. 3 with respect to the reflected light RLIG of the object OBJ. As shown in Equations 1 and 2, in order to form (calculate) one scene regarding the object OBJ, first through fourth pixel output signals A0 through A3 corresponding to the first through fourth modulation signals SIGD0 through SIGD3 respectively modulated by 0°, 90°, 180°, and 270° may be used.

A method of calculating the depth information DINF in units of the pixels PX is described above. A method of calculating the depth information DINF in units of images each formed of the pixel output signals POUT from N*M pixels PX (N and M are integers equal to or greater than 2) will now be described. FIG. 1 does not illustrate an image formed of the pixel output signals POUT output from a plurality of pixels PX. However, a sampling unit SM connected to an output terminal of the pixel array PA or a buffer (not shown) before or after the analog-digital converter ADC can form the pixel output signals POUT output from a plurality of pixels PX as a single image.

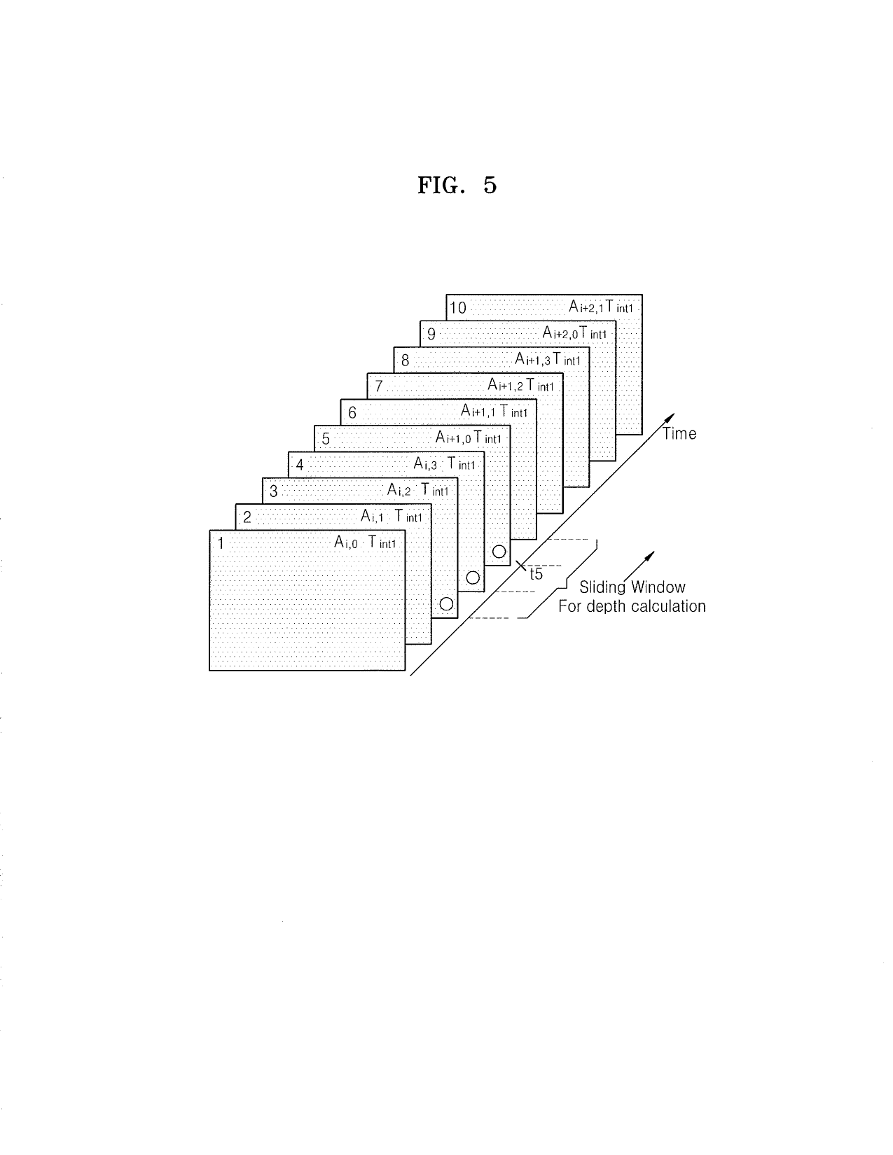

FIG. 5 illustrates a diagram showing an example of a sequence of images captured from continuously received reflected light RLIG.

In FIG. 5, it is assumed that an image formed of the pixel output signals POUT from N*M pixels PX is A_{j,k}. Here, k corresponds to a modulated phase. If the number of pixel output signals POUT (phases) required when the image sensor ISEN forms one scene regarding the object OBJ (calculates the depth information DINF with respect to one scene) is four as described above, k may be 0, 1, 2, and 3. Also, j is the number of scenes regarding the object OBJ. For example, i^{th} scene (i is a natural number equal to or less than j) may be formed of images corresponding to modulated phases 0°, 90°, 180°, and 270°, i.e., an image A_{i,0} formed of the pixel output signals POUT corresponding to modulated phases 0°, an image A_{i,1} formed of the pixel output signals POUT corresponding to modulated phases 90°, an image A_{i,2} formed of the pixel output signals POUT corresponding to modulated phases 180°, and an image A_{i,3} formed of the pixel output signals POUT corresponding to modulated phases 270°.

In FIG. 5, images have the same integration time Tᵢₙₜ (a first integration time Tᵢₙₜ₁). A method of calculating the depth information DINF (the distance D) in this case will now be described.

In FIG. 5, four images substituted in Equations 3 through 8 to calculate the depth information DINF at one time are included in a sliding window. If the image sensor ISEN completely calculates the depth information DINF regarding the images A_{i,0} through A_{i,3} of the i^{th} scene, the sliding window moves in a direction of an arrow. As such, it is assumed that the image sensor ISEN captures an image A_{i+1,0} that is newly included in the sliding window currently at a time=t5 after the image A_{i,3}. Also, it is assumed that the three images A_{i,1} through A_{1,3} recently captured by the image sensor ISEN and the image A_{i+1,0} currently captured at the time=t5 by the image sensor ISEN have the same integration time Tᵢₙₜ (the first integration time Tᵢₙₜ₁).

In this case, like a method of calculating the depth information DINF regarding the first through fourth pixel output signals A0 through A3 by using Equations 1 and 2, the depth information DINF (the distance D) at the time=t5 may be calculated by substituting a phase delay φ₀ obtained according to Equation 3 below in Equation 4.

$$\begin{matrix}{ϕ}_{0} = arctan ( \frac{{A}_{i , 3} - {A}_{i , 1}}{{A}_{i , 2} - {A}_{i + 1 , 0}} ) & [ Equation 3 ] \\ D = \frac{c}{4 \cdot {F}_{m} \cdot π} * {ϕ}_{0} & [ Equation 4 ]\end{matrix}$$

However, the first integration time Tᵢₙₜ of the three recently captured images A_{i,1}, A_{i,2}, and A_{i,3} may differ from the integration time Tᵢₙₜ of the image A_{i+1,0}newly captured at the time=t6.

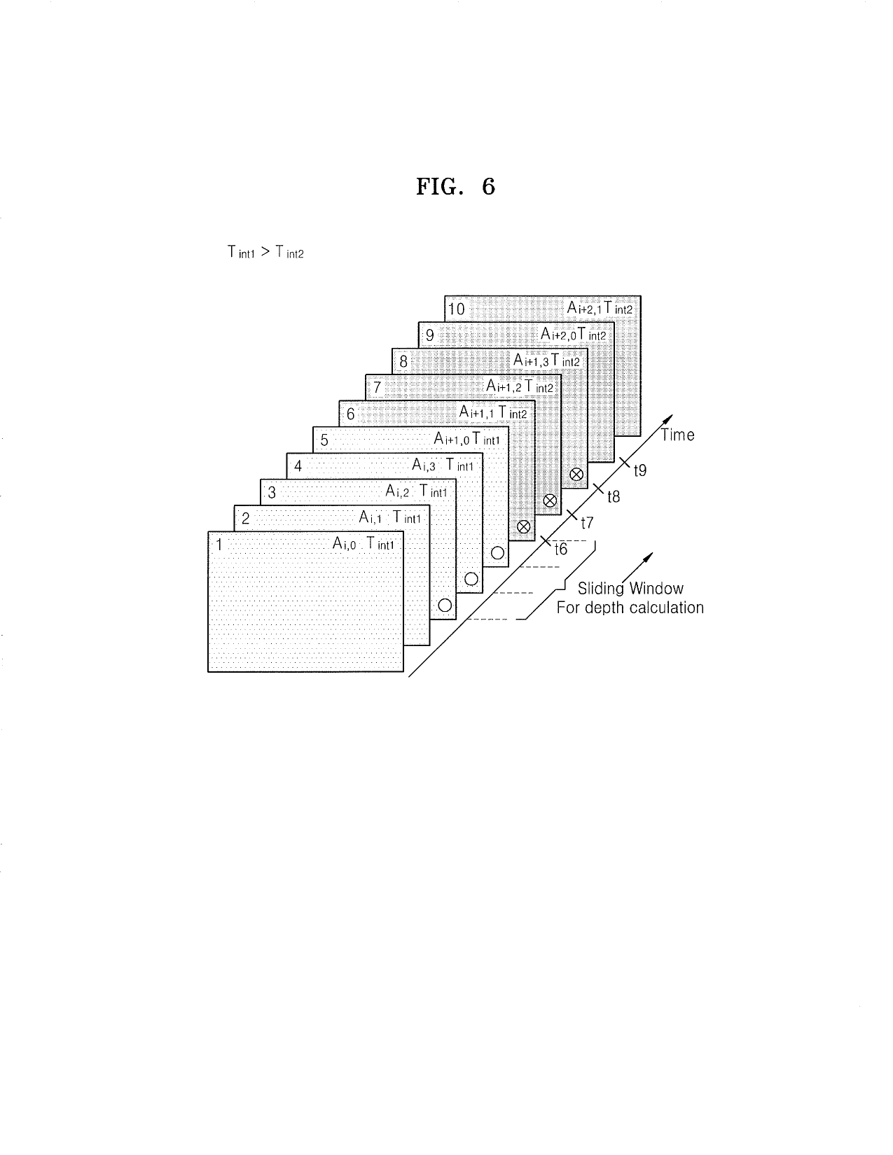

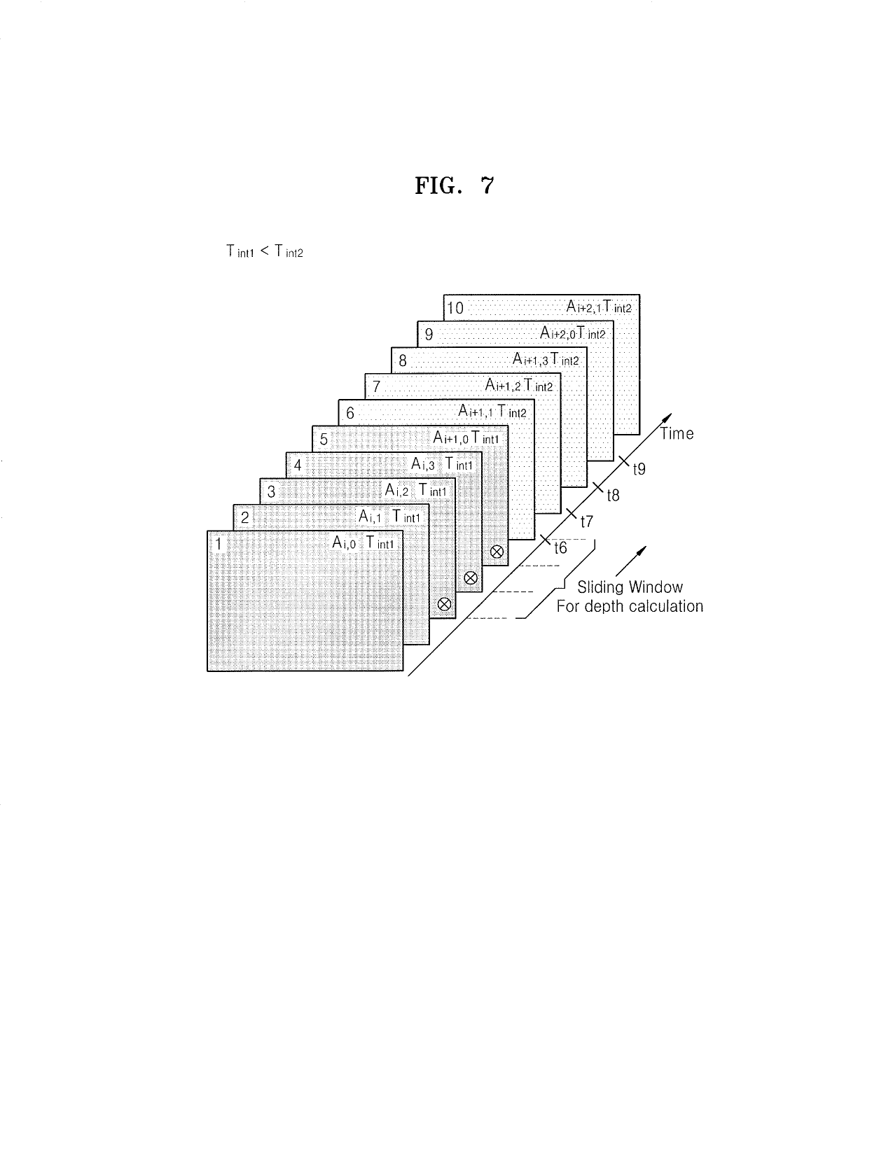

If a plurality of (four) images having different phases and substituted in Equations 3 through 8 in order to calculate the depth information DINF have different integration times Tᵢₙₜ, the depth information calculator DC may stop the calculation of the depth information DINF until the images have the same integration time Tᵢₙₜ. If the integration time Tᵢₙₜ has changed from the first integration time Tᵢₙₜ₁ into the second integration time Tᵢₙₜ₂ at the time=t6, as illustrated in FIGS. 6 and 7, the depth information calculator DC may stop the calculation of the depth information DINF until all images substituted in Equation 8 at the time=t9 have the same integration time Tᵢₙₜ (the second integration time Tᵢₙₜ₂). If the integration time Tᵢₙₜ has changed, an image to which the changed integration time Tᵢₙₜ is applied may be excessively or insufficiently exposed. If an image is excessively or insufficiently exposed, values of images substituted in Equations 3 through 8 are not constants, the depth information DINF may be calculated inaccurately or may not be calculated. However, if the calculation of the depth information DINF is stopped when the integration time Tᵢₙₜ has changed, an operation speed of the image sensor ISEN is reduced.

In contrast, in accordance with embodiments, the image sensor ISEN may accurately calculate the depth information DINF without stopping the calculation of the depth information DINF. A detailed description thereof will now be provided.

FIG. 6 illustrates a sequence of images when the integration time Tᵢₙₜ is reduced. In particular, the integration time Tᵢₙₜ is reduced such that Tᵢₙₜ₁>Tᵢₙₜ₂ at a current time t=t6.

Referring to FIGS. 1 through 6, the image A_{i+1,1} is captured at the current time t=t6 after distances D of the images A_{i,2}, A_{i,}3, A_{i+1,0}, and A_{i+1,1} are calculated as in FIG. 5. In this regard, the integration time Tᵢₙₜ of the recently captured three images A_{i,2}, A_{i,3}, and A_{i+1,0} is the first integration time Tᵢₙₜ₁, the integration time Tᵢₙₜ of the image A_{i,1} captured at the current time t=t6 is the second integration time Tᵢₙₜ₂. The first integration time Tᵢₙₜ₁ and the second integration time Tᵢₙₜ₂ may differ. When the integration time Tᵢₙₜ is reduced from the first integration time Tᵢₙₜ₁ to the second integration time Tᵢₙₜ₂ during a calculation of the depth information DINF, the depth information calculation unit DC of the present embodiment may calculate a phase delay φ₁ for the images A_{i,2}, A_{i,3}, A_{i+1,0}, and A_{i+1,1} by multiplying a gain G to the image A_{i,1} whose integration time Tᵢₙₜ is reduced according to Equation 5 below.

$${ϕ}_{1} = arctan ( \frac{{A}_{i , 3} - ( {A}_{i + 1 , 1} \cdot G )}{{A}_{i , 2} - {A}_{i + 1 , 0}} ) \qquad [ Equation 5 ]$$

The distances D can be calculated by substituting the phase delay φ₁ in Equation 5 above, i.e., the phase delay φ₁ substituted in Equation 5 is replaced with the phase delay φ₀ in Equation 4. This will apply to a phase delay that will be described below.

The integration time register TR of the present embodiment obtains the gain G of a ratio between the first integration time Tᵢₙₜ₁ and the second integration time Tᵢₙₜ₂ according to Equation 6 below.

$$G = max ( \frac{{T}_{int 1}}{{T}_{int 2}} , \frac{{T}_{int 2}}{{T}_{int 1}} ) \qquad [ Equation 6 ]$$

The integration time register TR of the present embodiment transmits the gain G obtained by using Equation 6 above to the depth calculation unit DC. The integration time register TR may obtain the gain G in a digital manner, e.g., using software, or in an analog manner, e.g., using a circuit.

In Equation 5 above, pixel output signals A0˜A3 used to form the images A_{i,2}, A_{i,3}, A_{i+1,0}, and A_{i+1,1} have a value 0 in a black level. However, the images A_{i,2}, A_{i,3}, A_{i+1,0}, and A_{i+1,1} may have an optional value B with respect to the reflected light RLIG of the black level. That is, if the images A_{i,2}, A_{i,3}, A_{i+1,0}, and A_{i+1,1} have the optional value B in the black level, the phase delay φ may be obtained by subtracting the optional value B from a corresponding image(s), applying the gain G to the corresponding image(s), and adding the optional value B to the corresponding image(s) as shown in Equation 7 below. This is in order to maintain linearity of the depth information DINF although the gain G is applied.

$${ϕ}_{1} = arctan ( \frac{{A}_{i , 3} - ( ( {A}_{i + 1 , 1} - B ) \cdot G + B )}{{A}_{i , 2} - {A}_{i + 1 , 0}} ) \qquad [ Equation 7 ]$$

Hereinafter, an actual value of the black level is reflected as in Equation 7 in order to accurately calculate the depth information DINF.

Referring still to FIGS. 1 through 6, the image A_{i+1,2} is captured at a current time t=t7 after the distances D of the images A_{i,2}, A_{i,3}, A_{i+1,0}, and A_{i+1,1} are calculated. In this regard, the integration time Tᵢₙₜ of the images A_{i,3} and A of the recently captured three images A_{i,3}, A_{i+1,0}, and Aᵢ₊ᵢ may be the first integration time Tᵢₙₜ₁, the integration time Tᵢₙₜ of the image A_{i,1}, and the image A_{i+1,2} captured at the current time t=t7 may be the second integration time Tᵢₙₜ₂. The second integration time Tᵢₙₜ₂ may be shorter than the first integration time Tᵢₙₜ₁ as described above.

A phase delay φ₂ for the images A_{i,3}, A_{i+1,0}, A_{i+1,1}, and A_{i+1,2} may be obtained according to Equation 8 below in which the gain G is applied to the images A_{i+1,1} and A_{i+1,2} having a reduced integration time.

$${ϕ}_{2} = arctan ( \frac{{A}_{i , 3} - ( ( {A}_{i + 1 , 1} - B ) \cdot G + B )}{( ( {A}_{i + 1 , 2} - B ) \cdot G + B ) - {A}_{i + 1 , 0}} ) \qquad [ Equation 8 ]$$

Referring still to FIGS. 1 through 6, the image A_{i+1,3} is captured at a current time t=t8 after the distances D of the images A_{i,3}, A_{i+1,}0, A_{i+1,1}, and A_{i+1,2} are calculated. In this regard, the integration time Tᵢₙₜ of the image A_{i+1,0} of the recently captured three images A_{i+1,0}, A_{i+1,1}, and A_{i+1,2} may be the first integration time Tᵢₙₜ₁, the integration time Tᵢₙₜ of the images Ai_{+1,1} and A_{i+1,2}, and the image A_{i+1,3} captured at the current time t=t8 may be the second integration time Tᵢₙₜ₂. The second integration time Tᵢₙₜ₂ may be shorter than the first integration time Tᵢₙₜ₁ as described above.

A phase delay φ₃ for the images A_{i+1,0}, A_{i+1,1}, A_{i+1,2}, and A_{i+1,3} may be obtained according to Equation 9 below in which the gain G is applied to the images A_{i+1,1}, A_{i+1,2}, and A_{i+1,3} having a reduced integration time.

$${ϕ}_{3} = arctan ( \frac{( ( {A}_{i + 1 , 3} - B ) \cdot G + B ) - ( ( {A}_{i + 1 , 1} - B ) \cdot G + B )}{( ( {A}_{i + 1 , 2} - B ) \cdot G + B ) - {A}_{i + 1 , 0}} ) = arctan ( \frac{( {A}_{i + 1 , 3} - {A}_{i + 1 , 1} ) \cdot G}{( ( {A}_{i + 1 , 2} - B ) \cdot G + B ) - {A}_{i + 1 , 0}} ) \qquad [ Equation 9 ]$$

Next, the image A_{i+2,0} is captured at a current time t=t9 after the distances D of the images A_{i+1,0}, A_{i+1,1}, A_{i+1,2}, and A_{i+1,3} are calculated. The integration time Tᵢₙₜ of the recently captured images A_{i+1,1}, A_{i+1,2}, and A_{i+1,3}, and the image A_{i+2,0} captured at the current time t=t9 is the same as the second integration time Tᵢₙₜ₂. Thus, like Equation 3 in which a delay phase is obtained for the same integration time, a phase delay φ₄ for the images A_{i+1,1}, A_{i+1,2}, Aᵢ₊₁,3, and A_{i+2,0} may be accurately obtained according to Equation 10 below without applying the gain G thereto.

$${ϕ}_{4} = arctan ( \frac{{A}_{i + 1 , 3} - {A}_{i + 1 , 1}}{{A}_{i + 1 , 2} - {A}_{i + 2 , 0}} ) \qquad [ Equation 10 ]$$

Next, a method of compensating for a change in the integration time when the integration time Tᵢₙₜ increases during a calculation of depth information will now be described.

FIG. 7 illustrates a sequence of images when the integration time Tᵢₙₜ increases. In particular, the integration time Tᵢₙₜ increases at the current time t=t6.

Referring to FIGS. 1 through 7, the image A_{i+1,1} is captured at the current time t=t6 after distances D of images including the image A_{i+1,0} are calculated as in FIG. 5. In this regard, the integration time Tᵢₙₜ of the recently captured three images A_{i,2}, A_{i,3}, and A_{i+1,0} is the first integration time Tᵢₙₜ₁ , the integration time Tᵢₙₜ of the image A_{i,1} captured at the current time t=t6 is the second integration time Tᵢₙₜ₂. The first integration time Tᵢₙₜ₁ and the second integration time Tᵢₙₜ₂ may differ. When the integration time Tᵢₙₜ increases from the first integration time Tᵢₙₜ₁ to the second integration time Tᵢₙₜ₂ during a calculation of the depth information DINF, the depth information calculation unit DC of the present embodiment may calculate the phase delay φ₁ for the images A_{i,2}, A_{i,3}, A_{i+1,0}, and A_{i+1,1} by multiplying the gain G to an image(s) before the integration time Tᵢₙₜ increases, i.e., the images A_{i,2}, A_{i,3}, and A_{i+1,0} having the integration time Tᵢₙₜ₁ , according to Equation 11 below.

$${ϕ}_{1} = arctan ( \frac{( ( {A}_{i + 1 , 3} - B ) \cdot G + B ) - {A}_{i + 1 , 1}}{( ( {A}_{i , 2} - B ) \cdot G + B ) - ( ( {A}_{i + 1 , 0} - B ) \cdot G + B )} ) = arctan ( \frac{( ( {A}_{i , 3} - B ) \cdot G + B ) - {A}_{i + 1 , 1}}{( {A}_{i , 2} - {A}_{i + 1 , 0} ) \cdot G} ) \qquad [ Equation 11 ]$$

As described above, the integration time register TR of the present embodiment obtains the gain G of a ratio between the first integration time Tᵢₙₜ₁ and the second integration time Tᵢₙₜ₂ according to Equation 6.

Continuously, the image A_{i+1,2} is captured at the current time t=t7 after the distances D of the images including the image A_{i+1,1} are calculated. In this regard, the integration time Tᵢₙₜ of the images A_{i,3} and A_{i+1,0} of the recently captured three images A_{i,3} A_{i+1,0}, and Aᵢ₊₁ may be the first integration time Tᵢₙₜ, the integration time Tᵢₙₜ of the image A_{i,1}, and the image A_{i+1,2} captured at the current time t=t7 may be the second integration time Tᵢₙₜ₂. The second integration time Tᵢₙₜ₂ may be longer than the first integration time Tᵢₙₜ₁ as described above.

The phase delay φ₂ for the images A_{i,3} A_{i+1,0}, Aᵢ₊₁, and A_{i+1,2} may be obtained according to Equation 12 below in which the gain G is applied to the images A_{i,3} and A_{i+1,0} having the first integration time Thᵢₙₜ₁.

$${ϕ}_{2} = arctan ( \frac{( ( {A}_{i , 3} - B ) \cdot G + B ) - {A}_{i + 1 , 1}}{{A}_{i + 1 , 2} - ( ( {A}_{i + 1 , 0} - B ) \cdot G + B )} ) \qquad [ Equation 12 ]$$

Continuously, the image A_{i+1,3} is captured at the current time t=t8 after the distances D of the images including the image A_{1+1,2} are calculated. In this regard, the integration time Tᵢₙₜ of the image A_{i+1,0} of the recently captured three images A_{i+1,0}, Aᵢ₊₁, and A_{i+1,2} may be the first integration time Tᵢₙₜ₁, the integration time Tᵢₙₜ of the images Aᵢ₊₁, and A_{i+1,2}, and the image A_{i+1,3} captured at the current time t=t8 may be the second integration time Tᵢₙₜ₂. The second integration time Tᵢₙₜ₂ may be longer than the first integration time Tᵢₙₜ₁ as described above.

The phase delay φ₃ for the images A_{i+1,0}, Aᵢ₊₁, A_{i+1,2}, and A_{i+1,3} may be obtained according to Equation 13 below in which the gain G is applied to the image A_{i+1,0} having the first integration time Tᵢₙₜ₁.

$${ϕ}_{3} = arctan ( \frac{{A}_{i + 3 , 1} - {A}_{i + 1 , 1}}{{A}_{i + 1 , 2} - ( ( {A}_{i + 1 , 0} - B ) \cdot G + B )} ) \qquad [ Equation 13 ]$$

Next, the image A_{i+2,0} is captured at the current time t=t9 after the distances D of the images including the image A_{i+1,3} are calculated. The integration time Tᵢₙₜ of the recently captured images Aᵢ₊₁, A_{i+1,2}, and A_{i+1,3}, and the image A_{i+2,0} captured at the current time t=t9 is the same as the second integration time Tᵢₙₜ₂. Thus, like Equation 3 in which a delay phase is obtained for the same integration time, the phase delay φ₄ for the images Aᵢ₊₁, A_{i+1,2}, A_{1+1,3}, and A_{i+2,0} may be accurately obtained according to Equation 14 below without applying the gain G thereto.

$${ϕ}_{4} = arctan ( \frac{{A}_{i + 1 , 3} - {A}_{i + 1 , 1}}{{A}_{i + 1 , 2} - {A}_{i + 2 , 0}} ) \qquad [ Equation 14 ]$$

The integration time register TR obtained the gain G greater than 1 for an image having a relatively short integration time Tᵢₙₜ like Equation 6 in order to compensate for values (values of pixel output signals) of the images in accordance with the change in the integration time Tᵢₙₜ.

The depth information may be calculated from a batch of Z raw frames, where the frames in the batch may have different integration times. In that batch, images having the longest integration time are identified. Those images may remain unaltered. Subsequently, a gain factor is calculated for each of the other images in the batch using Equation 6 and applied to the corresponding image. Black level subtraction should be handled by following the examples described above.

The range of pixel values in the embodiment can be limited. For example, the number of bits in a software variable or hardware register representing a pixel value can be limited. In such case the multiplication of an image by a gain factor greater than one can result in some pixels having relatively high values to exceed the maximum allowed value. Correspondingly, it may be taken to set the resulting values to the maximum allowed value and/or to mark pixel values as invalid or ‘saturated’ and subsequently apply methods known in the art to attempt calculating depth while some or all pixel values are invalid or to mark the depth of the corresponding pixel in the output image as unknown.

The gain factor can be less than 1. In this case images in the batch having the shortest integration time are identified. Those images may remain unaltered. Subsequently, a gain factor is calculated for each of the other images in the batch as the reciprocate value of the output of Equation 6 and applied to the corresponding image.

Correspondingly, it may be taken in this case to properly handle saturated pixels, that is pixels having values that have exceeded limits imposed by the readout chain or preceeding processing, such that the resulting values has become invalid or inaccurate. For example, if these pixels have not been already marked as invalid, such pixels can be marked invalid and subsequently processed by methods known in the art to attempt calculating depth while some or all pixel values are invalid or the depth of the corresponding pixel in the output image can be marked as unknown.

Furthermore, from the descriptions and examples it can recognize that image gains can be calculated in various ways as long as the resulting exposures of each image in the batch become equal and, when applicable, issues with saturated pixels are handled as mentioned above.

As described above, the image sensor ISEN of the present embodiment may accurately calculate depth information without stopping the calculation of the depth information by compensating for a change in an integration time during calculation of the depth information.

Referring back to FIG. 1, the color information calculator CC of the image sensor ISEN may calculate and output the color information CINF using the pixel output signals POUTc output from the color pixels PXc or color and depth information detectable pixels of the pixel array PA, and are analog-digital converted. A method of calculating the color information CINF is not described in detail here.

Although the image sensor ISEN of the present embodiment compensates for a difference in an integration time between captured images, the present embodiment is not limited thereto. The image sensor ISEN of the present embodiment may apply a gain G′ that compensates for a change (from R1 to R2) of the radiance R for the captured images according to Equation 15 below.

$${G}^{″} = max ( \frac{{R}_{2}}{{R}_{1}} , \frac{{R}_{1}}{{R}_{2}} ) \\ or \\ {G}^{″} = min ( \frac{{R}_{2}}{{R}_{1}} , \frac{{R}_{1}}{{R}_{2}} ) \qquad [ Equation 15 ]$$

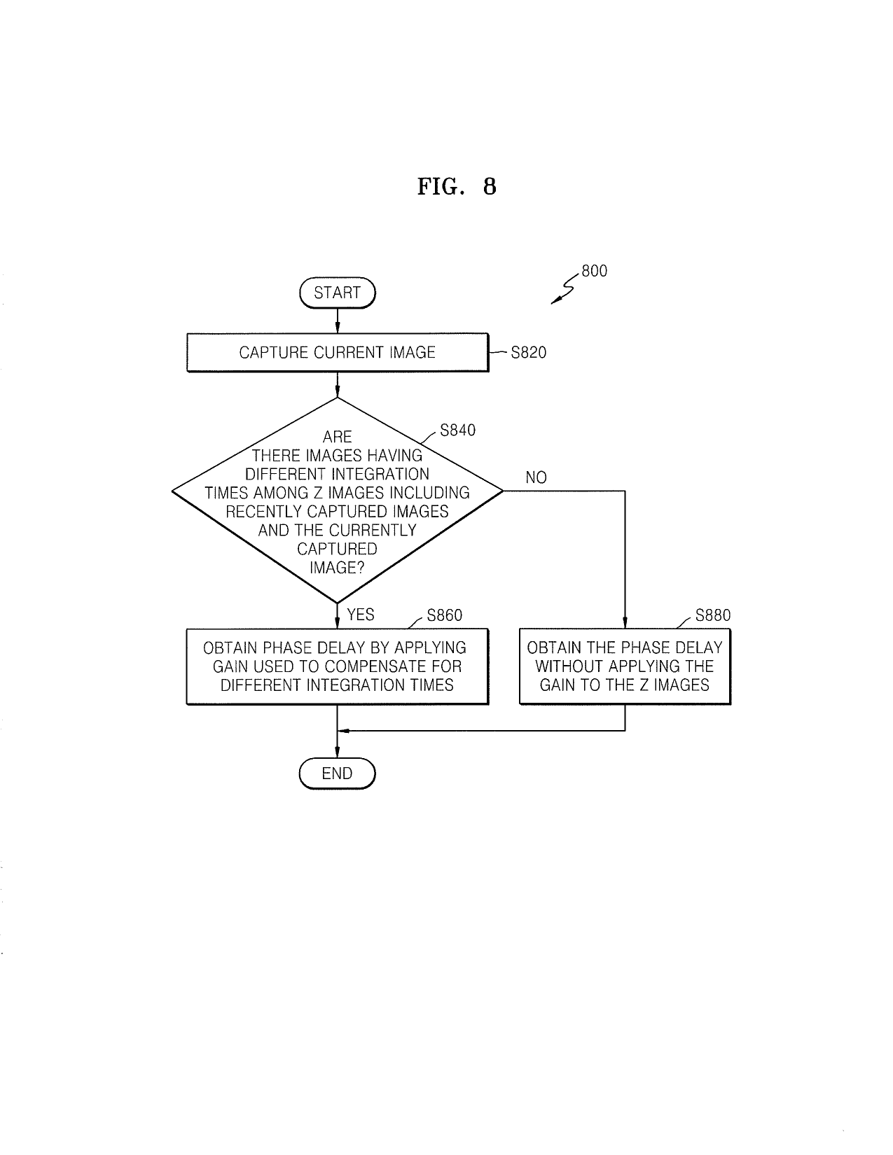

FIG. 8 illustrates a flowchart of an image sensing method 800 according to an embodiment.

Referring to FIGS. 1 through 8, the image sensing method 800 obtains the phase delay φ for Z images using recently captured Z-1 images and a currently captured image when the number of modified signals is Z (Z=4 in FIG. 4) (operation S820). If an integration time for the currently captured image is not the same as that for the recently captured Z-1 images (“yes” in operation S840), the delay φ is obtained (operation S860) by applying the gain G to an image(s) having a different integration time. If an integration time for the currently captured image is the same as that for the recently captured Z-1 images (“no” in operation S840), the delay φ is obtained (operation S890) without applying the gain G to the images. This is described in detail with reference to Equations 5 through 21. As described above, the gain G of the present embodiment may be the gain G′ obtained according to Equation 15.

In this manner, the integration time is corrected for images having different integration time among the recently captured Z-1 images and the currently captured image.

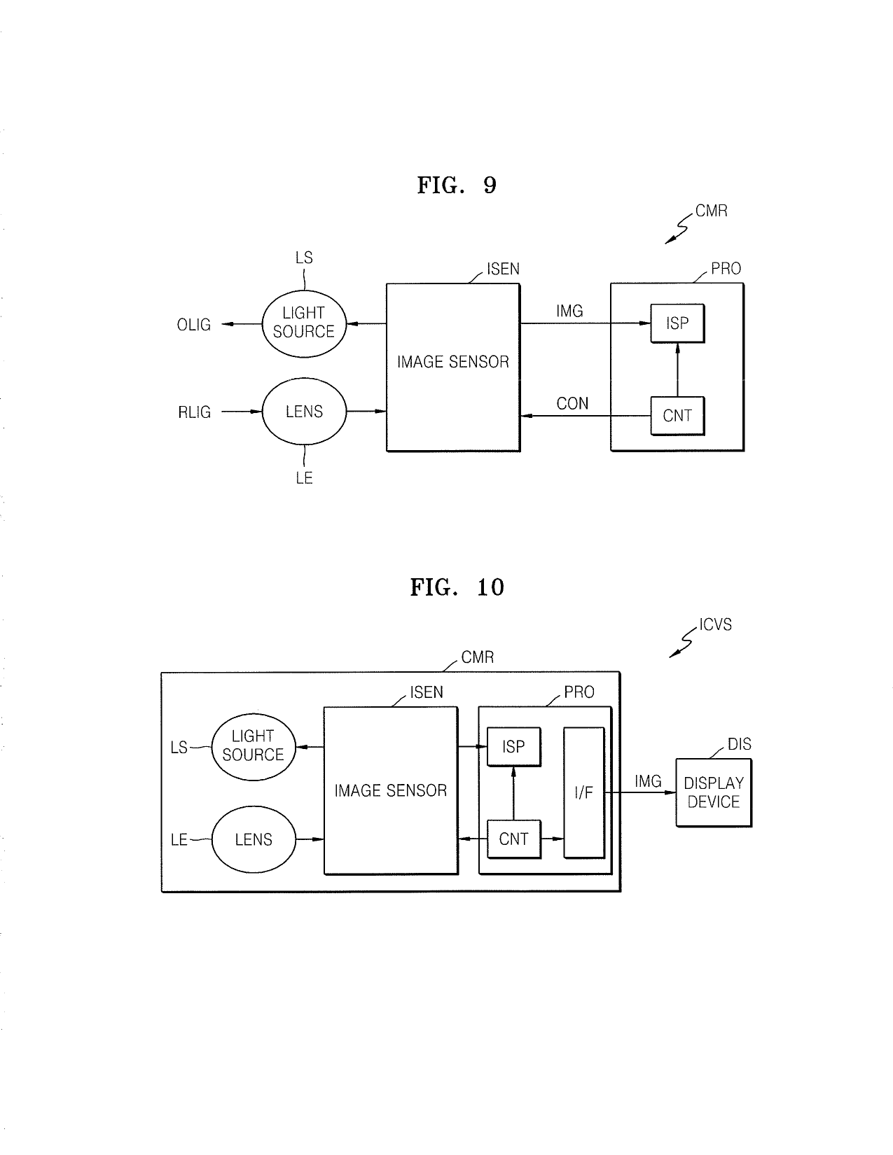

FIG. 9 illustrates a block diagram of an image capturing apparatus CMR according to an embodiment of the inventive concept.

Referring to FIGS. 1 and 9, the image capturing apparatus CMR may include the image sensor ISEN for sensing image information IMG regarding the object OBJ by receiving via the lens LE the reflected light RLIG that is formed when the output light OLIG emitted from the light source LS is reflected on the object OBJ. The image capturing apparatus CMR may further include a processor PRO including a controller CNT for controlling the image sensor ISEN by using a control signal CON, and a signal processing circuit ISP for signal-processing the image information IMG sensed by the image sensor ISEN.

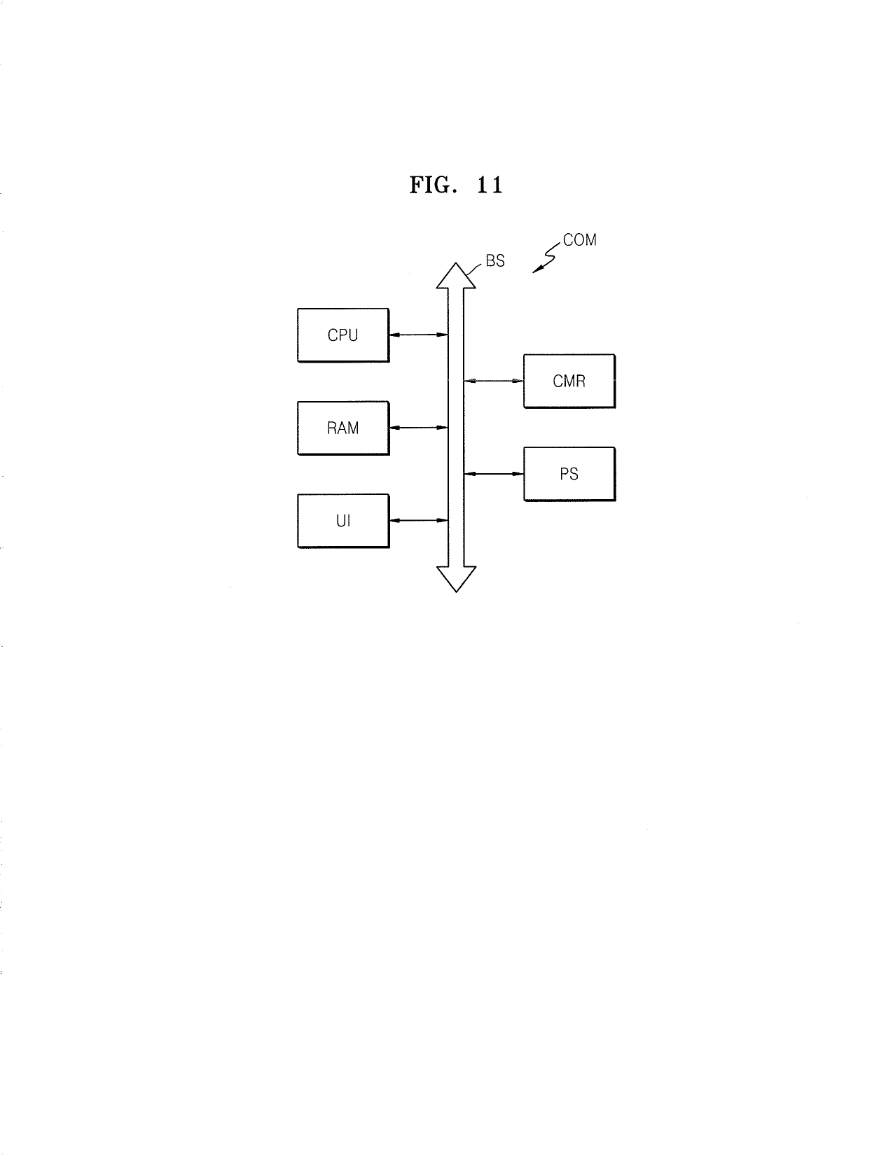

FIG. 10 illustrates a block diagram of an image capture and visualizaion system ICVS according to an embodiment of the inventive concept.

Referring to FIG. 10, the image capture and visualizaion system ICVS may include the image capturing apparatus CMR illustrated in FIG. 9, and a display device DIS for displaying an image received from the image capturing apparatus CMR. For this, the processor PRO may further include an interface I/F for transmitting to the display device DIS the image information IMG received from the image sensor ISEN.

FIG. 11 illustrates a block diagram of a computing system COM according to an embodiment of the inventive concept.

Referring to FIG. 11, the computing system COM includes a central processing unit (CPU), a user interface (UI), and the image capturing apparatus CMR which are electrically connected to a bus BS. As described above in relation to FIG. 11, the image capturing apparatus CMR may include the image sensor ISEN and the processor PRO.

The computing system COM may further include a power supply PS. Also, the computing system COM may further include a storing device RAM for storing the image information IMG transmitted from the image capturing apparatus CMR.

If the computing system COM is a mobile apparatus, the computing system COM may additionally include a battery for applying an operational voltage to the computing system COM, and a modem such as a baseband chipset. Also, it is well known to one of ordinary skill in the art that the computing system COM may further include an application chipset, a mobile dynamic random access memory (DRAM), and the like, and thus detailed descriptions thereof is not provided here.

By way of summary and review, according to embodiments, when integration times corresponding to the images used to calculate the depth information are different, one integration time of the integration times may be selected as a reference integration time. A gain for an image having a corresponding integration time different from the reference integration time may be used to adjust the depth information accordingly. The gain may be proportional to a difference between the corresponding integration time and the reference integration time. In accordance with embodiments, the reference integration time may be the longest integration time of the integration times or the shortest integration time of the integration times. When the reference integration time is the longest integration time, the gain may be the ratio of the reference integration time to the corresponding integration time. When the reference integration time is the shortest integration time, the gain may be the ratio of the corresponding integration time to the reference integration time. Thus, according to embodiments, the depth information may be accurately calculated from images having different integration times without stopping the calculation of the depth information.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An image sensor for receiving reflected light from an object having output light incident thereon, the image sensor comprising:
a pixel array having a plurality of pixels for sensing a plurality of modulation signals having different phases from the reflected light and outputting pixel output signals corresponding to the plurality of modulation signals;
a depth information calculation unit for estimating a delay between the output light and the reflected light from images formed by the pixel output signals and calculating depth information regarding the object; and
an integration time register that, when integration times corresponding to the images used to calculate the depth information in the depth information calculation unit are different, obtains a gain corresponding to a difference between the integration times,
wherein the depth information calculation unit applies the gain to images having different integration times when the integration times corresponding to the images used to calculate the depth information in the depth information calculation unit are different from each other.

2. The image sensor as claimed in claim 1, wherein, when the integration time corresponding to each of the images is a first integration time or a second integration time, the gain is a ratio of the first integration time and the second integration time.

3. The image sensor as claimed in claim 2, wherein:
the integration time register sets the gain greater than 1, and
the depth information calculation unit applies the gain for at least one image having a shorter one of the first integration time and the second integration time.

4. The image sensor as claimed in claim 2, wherein:
the integration time register sets the gain smaller than 1, and
the depth information calculation unit applies the gain for at least one image having a longer one of the first integration time and the second integration time.

5. The image sensor as claimed in claim 1, wherein the depth information calculation unit subtracts a value of a black level from the value of one image among the images having different integration times, applies the gain to the resulting value, and adds the value of the black level to the one image having the gain applied thereto.

6. The image sensor as claimed in claim 1, wherein each of the plurality of modulation signals is phase modulated to one of 0 degree, 90 degrees, 180 degrees, and 270 degrees with respect to the output light.

7. The image sensor as claimed in claim 1, wherein:
the pixel array includes:
color pixels for generating the pixel output signals by receiving a wavelength of a band for detecting color information of the object from the reflected light; and
depth pixels for generating the pixel output signals by receiving a wavelength of a band for detecting depth information of the object from the reflected light, and
the image sensor further includes a color information calculation unit for receiving the pixel output signals output from the color pixels and calculating the color information.

8. The image sensor as claimed in claim 1, wherein the image sensor is a time of flight (TOF) sensor.

9. An image sensing method, comprising:
receiving reflected light from an object having output light incident thereon;
sensing a plurality of modulation signals having different phases from the reflected light and outputting pixel output signals corresponding to the plurality of modulation signals;
estimating a delay between the output light and the reflected light from images having the same number as types of the plurality of modulation signals among images formed by the pixel output signals and are continuously sensed; and
calculating depth information regarding the object, wherein calculating the depth information includes, when integration times corresponding to the images having the same number as types of the plurality of modulation signals used to calculate the depth information are different from each other, applying a gain corresponding to a difference between the integration times to the images having different integration times.

10. The method as claimed in claim 9, wherein, when the integration time corresponding to each of the images used to calculate the depth information is first integration time or the second integration time, the gain is a ratio of the first integration time and the second integration time.

11. The method as claimed in claim 10, wherein, when the gain is greater than 1, applying the gain to at least one image having a shorter one of the first integration time and the second integration time.

12. The method as claimed in claim 10, wherein, when the gain is smaller than 1, applying the gain to at least one image having a longer one of the first integration time and the second integration time.

13. The method as claimed in claim 9, wherein calculating of the depth information includes:
subtracting a value of a black level from the value of an image among the images having different integration times;
applying the gain to the one image after subtracting the value of the black level therefrom; and
adding the value of the black level to the one image to which the gain has been applied.

14. The method as claimed in claim 9, wherein each of the plurality of modulation signals is phase modulated to one of 0 degree, 90 degrees, 180 degrees, and 270 degrees with respect to the output light.

15. The method as claimed in claim 9, further comprising:
receiving the pixel output signals output from the color pixels; and
calculating the color information regarding the object.

16. An image sensor for receiving reflected light from an object having output light incident thereon, the image sensor comprising:
a pixel array having a plurality of pixels for sensing a plurality of modulation signals having different phases from the reflected light and outputting pixel output signals corresponding to the plurality of modulation signals;
a depth information calculation unit for estimating a delay between the output light and the reflected light from images formed by the pixel output signals and calculating depth information regarding the object in accordance with the delay; and
an integration time register that, when integration times corresponding to the images used to calculate the depth information in the depth information calculation unit are different, selects a reference integration time from the integration times and obtains a corresponding gain for a corresponding image having a corresponding integration time different from the reference integration time, the corresponding gain being proportional to a difference between the corresponding integration time and the reference integration time,
wherein the depth information calculation unit applies corresponding gains to corresponding images having integration times different from the reference integration time.

17. The image sensor as claimed in claim 16, wherein the reference integration time is a longest integration time of the integration times.

18. The image sensor as claimed in claim 17, wherein the corresponding gain is the ratio of the reference integration time to the corresponding integration time.

19. The image sensor as claimed in claim 16, wherein the reference integration time is a shortest integration time of the integration times.

20. The image sensor as claimed in claim 19, wherein the corresponding gain is the ratio of the corresponding integration time to the reference integration time.
